(19) United States
(12) Patent Application Publication
(10) Pub. No.: US 2023/0022684 A1
(43) Pub. Date: Jan. 26, 2023

(54) FANTASY SPORTS GAMES

(71) Applicant: DANE & DINGO LLC, Rio Rancho, NM (US)

(72) Inventors: Hans Kayser, III, Rio Rancho, NM (US); Drew Nelson, Martinez, CA (US)

(21) Appl. No.: 17/865,139

(22) Filed: Jul. 14, 2022

Related U.S. Application Data
(60) Provisional application No. 63/221,890, filed on Jul. 14, 2021.

(51) Int. Cl. A63F 13/828; A63F 13/537

(52) U.S. Cl. CPC A63F 13/828; A63F 13/537

(57) ABSTRACT

A method and system for fantasy games comprises a computer system further comprising at least one processor, a graphical user interface, and a computer-usable medium embodying computer program code, the computer-usable medium capable of communicating with the at least one processor, the non-transitory computer program code comprising instructions executable by the at least one processor and configured for: defining a fantasy team, the fantasy team comprising multiple real world players selected from a single real world team, collecting sports data, assigning fantasy points to the fantasy team based on the sports data of the real world players selected from the single real world team, and summing the fantasy points for all the fantasy team into a fantasy score.

### CROSS REFERENCE TO RELATED PATENT APPLICATIONS

This application claims the priority and benefit under 35 U.S.C. § 119(e) of U.S. Provisional Patent Application Ser. No. 63/221,890 filed Jul. 14, 2021, entitled “FANTASY SPORTS GAMES.” U.S. Provisional Patent Application Ser. No. 63/221,890 is herein incorporated by reference in its entirety.

### TECHNICAL FIELD

Embodiments are generally related to the field of games. Embodiments are also related to the field of web applications. Embodiments are further related to the field of computer devices and mobile devices used for fantasy competitions. Embodiments are also related to methods, systems, and devices for implementing fantasy sports and fantasy games based on real word statistics and statistical projections.

### BACKGROUND

Fantasy sports are quickly becoming one of the most popular recreational activities worldwide. Fantasy sports are engaging because they allow participants to vicariously participate in and with real world sports, or other competitions. Originally developed in 1980 as a means for baseball fans to proactively engage in friendly competition, “rotisserie baseball” developed from a single group of friends to a nationwide phenomenon. Original iterations of fantasy sports required participants to track baseball statistics by hand using information taken from the stat lines of newspapers or other print media.

Participation in fantasy sports has exploded. As of 2021, an estimated 46 million people in the United States alone participate in fantasy sports. In addition, approximately 1 in 5 Americans 18+ years old participates in fantasy sports on some level. According to some sources, the fantasy sports market is currently approximately $18.6 Billion, and is expected to more than double by the year 2027.

In traditional fantasy sports leagues, participants construct lineups using players from a variety of teams in any given league/sport. Each player in the league then competes against another player in the league, with points being awarded according to the real-world statistical performance of the athletes in the players' respective lineups.

More recently new variants of fantasy sports have been developed. One such method is a single tournament style competition where each player selects a lineup. Each player in the tournament then competes against all the other players with the high score winning the tournament.

While fantasy sports are engaging and fun, there remain various limitations to current varieties of fantasy sports. For example, most fantasy contests require significant time and effort in order to fully comprehend the rules of the game. This steep learning curve tends to limit the success of new players, and may discourage robust recruitment into the game.

Accordingly, there is a need in the art for methods and systems that provide new, simple varieties of fantasy based contests as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for games.

It is another aspect of the disclosed embodiments to provide a method, system, and apparatus for fantasy games based on real world outcomes and events.

It is another aspect of the disclosed embodiments to provide methods and systems, for computer and mobile based fantasy sports and fantasy games based on real world statistics and statistical projections.

For example, In an embodiment, a system for fantasy games comprises a computer system further comprising: at least one processor; a graphical user interface; and a computer-usable medium embodying computer program code, the computer-usable medium capable of communicating with the at least one processor, the non-transitory computer program code comprising instructions executable by the at least one processor and configured for: defining a fantasy team, the fantasy team comprising multiple real world players selected from a single real world team, collecting sports data, assigning fantasy points to the fantasy team based on the sports data of the real world players selected from the single real world team, and summing the fantasy points for all the fantasy team into a fantasy score.

In an embodiment, the non-transitory computer program code comprising instructions executable by the at least one processor is further configured for comparing the fantasy score of the fantasy team to a second fantasy score of a second fantasy team, and identifying a winner based on which of the fantasy team and the second fantasy team have a higher score. In an embodiment, the non-transitory computer program code comprising instructions executable by the at least one processor is further configured for maintaining a leaderboard of the fantasy team, the second fantasy team, and additional fantasy teams.

In an embodiment, the multiple real world players comprise three real world players. In an embodiment, the non-transitory computer program code comprising instructions executable by the at least one processor is further configured for requiring the substitution of at least one of the three real world players for at least one other real world player from the same team between each game of the real world team. In an embodiment, the non-transitory computer program code comprising instructions executable by the at least one processor is further configured for designating one player on the real world team as a permanent member of the fantasy team, that is not required to be substituted.

In an embodiment, the non-transitory computer program code comprising instructions executable by the at least one processor is further configured for defining the fantasy team, as three real world players selected from a single real world team for each of a plurality of sports. In an embodiment, the plurality of sports comprise at least two of professional football, collegiate football, professional baseball, collegiate baseball, professional basketball, collegiate basketball, professional soccer, collegiate soccer, professional hockey, and collegiate hockey.

In an embodiment, the non-transitory computer program code comprising instructions executable by the at least one processor is further configured for awarding experience points according to the fantasy team performance. In an embodiment, the non-transitory computer program code comprising instructions executable by the at least one processor is further configured for awarding digital awards according to the fantasy team performance.

In another embodiment, a system for fantasy games comprises a computer system further comprising: at least one processor; a graphical user interface; and a computer-usable medium embodying computer program code, the computer-usable medium capable of communicating with the at least one processor, the non-transitory computer program code comprising instructions executable by the at least one processor and configured for: defining a plurality of fantasy teams, each of the plurality of fantasy teams comprising three real world players selected from a single real world team, collecting sports data comprising statistical data associated with the real world players, assigning fantasy points to each of the plurality fantasy teams based on the sports data, maintaining a leaderboard of the plurality of fantasy teams based on the fantasy points assigned to each of the plurality of fantasy teams.

In an embodiment, the non-transitory computer program code comprising instructions executable by the at least one processor is further configured for requiring the substitution of at least one of the three real world players for at least one other real world player from the same team between each game of the real world team. In an embodiment, the non-transitory computer program code comprising instructions executable by the at least one processor is further configured for defining the fantasy team, as three real world players selected from a single real world team for each of a plurality of sports.

In another embodiment, a computer implemented fantasy game method comprises defining a first fantasy team, the first fantasy team comprising multiple real world players selected from a single real world team, defining a second fantasy team, the second fantasy team comprising multiple real world players selected from a single real world team, collecting sports data, assigning fantasy points to the first fantasy team based on the sports data of the real world players selected from the single real world team to establish a first fantasy team score, assigning fantasy points to the second fantasy team based on the sports data of the real world players selected from the single real world team to establish a second fantasy team score, and identifying a winner between the first fantasy team and the second fantasy team by comparing a the first fantasy team score and the second fantasy team score.

In an embodiment, the multiple real world players comprise three real world players. In an embodiment, the method further comprises requiring the substitution of at least one of the three real world players for at least one other real world player from the same team between each game of the real world team.

In an embodiment, the method further comprises defining the fantasy team, as three real world players selected from a single real world team for each of a plurality of sports. In an embodiment, the plurality of sports comprise at least two of professional football, collegiate football, professional baseball, collegiate baseball, professional basketball, collegiate basketball, professional soccer, collegiate soccer, professional hockey, and collegiate hockey.

In an embodiment, the method further comprises awarding experience points according to the fantasy team performance. In an embodiment, the method further comprises awarding digital awards according to the fantasy team performance.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4A depicts a sports season chart, in accordance with the disclosed embodiments;

FIG. 4B depicts a tournament bracket, in accordance with the disclosed embodiments;

FIG. 5 depicts a block diagram of a game system, in accordance with the disclosed embodiments;

FIG. 6 depicts a block diagram of a game module, in accordance with the disclosed embodiments;

FIG. 7A depicts steps associated with a system sign up method associated with a fantasy game, in accordance with the disclosed embodiments;

FIG. 7B depicts steps associated with a player set up method associated with a fantasy game, in accordance with the disclosed embodiments;

FIG. 7C depicts steps associated with a fantasy game method, in accordance with the disclosed embodiments;

FIG. 8A illustrates a sign up/login workflow associated with a software implemented fantasy game, in accordance with the disclosed embodiments;

FIG. 8B illustrates a sign up workflow associated with a software implemented fantasy game, in accordance with the disclosed embodiments;

FIG. 8C illustrates aspects of an account creation workflow associated with a software implemented fantasy game, in accordance with the disclosed embodiments;

FIG. 8D illustrates aspects of an account creation workflow associated with a software implemented fantasy game, in accordance with the disclosed embodiments;

FIG. 8E illustrates a login workflow associated with a software implemented fantasy game, in accordance with the disclosed embodiments;

FIG. 8F illustrates a sport/league selection workflow associated with a software implemented fantasy game, in accordance with the disclosed embodiments;

FIG. 8G illustrates a team selection workflow associated with a software implemented fantasy game, in accordance with the disclosed embodiments;

FIG. 8H illustrates a team selection workflow associated with a software implemented fantasy game, in accordance with the disclosed embodiments;

FIG. 8I illustrates a home page workflow associated with a software implemented fantasy game, in accordance with the disclosed embodiments;

FIG. 8J illustrates a lineups workflow associated with a software implemented fantasy game, in accordance with the disclosed embodiments;

FIG. 8K illustrates a player selection workflow associated with a software implemented fantasy game, in accordance with the disclosed embodiments;

FIG. 8L illustrates a matchup workflow associated with a software implemented fantasy game, in accordance with the disclosed embodiments;

FIG. 8M illustrates a news and updates workflow associated with a software implemented fantasy game, in accordance with the disclosed embodiments;

FIG. 8N illustrates a leaderboard workflow associated with a software implemented fantasy game, in accordance with the disclosed embodiments;

FIG. 8O illustrates a league pre-signup workflow associated with a software implemented fantasy game, in accordance with the disclosed embodiments;

FIG. 8P illustrates a league start workflow associated with a software implemented fantasy game, in accordance with the disclosed embodiments;

FIG. 8Q illustrates a league invite workflow associated with a software implemented fantasy game, in accordance with the disclosed embodiments;

FIG. 8R illustrates a league post-signup workflow associated with a software implemented fantasy game, in accordance with the disclosed embodiments;

FIG. 8S illustrates a league standings workflow associated with a software implemented fantasy game, in accordance with the disclosed embodiments;

FIG. 8T illustrates a smackboard workflow associated with a software implemented fantasy game, in accordance with the disclosed embodiments;

FIG. 8U illustrates a my team workflow associated with a software implemented fantasy game, in accordance with the disclosed embodiments;

FIG. 8V illustrates an account workflow associated with a software implemented fantasy game, in accordance with the disclosed embodiments;

FIG. 8W illustrates a settings workflow associated with a software implemented fantasy game, in accordance with the disclosed embodiments;

FIG. 8X illustrates an invite others workflow associated with a software implemented fantasy game, in accordance with the disclosed embodiments;

FIG. 8Y illustrates a stats and achievements workflow associated with a software implemented fantasy game, in accordance with the disclosed embodiments; and

FIG. 8Z illustrates a payment workflow associated with a software implemented fantasy game, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

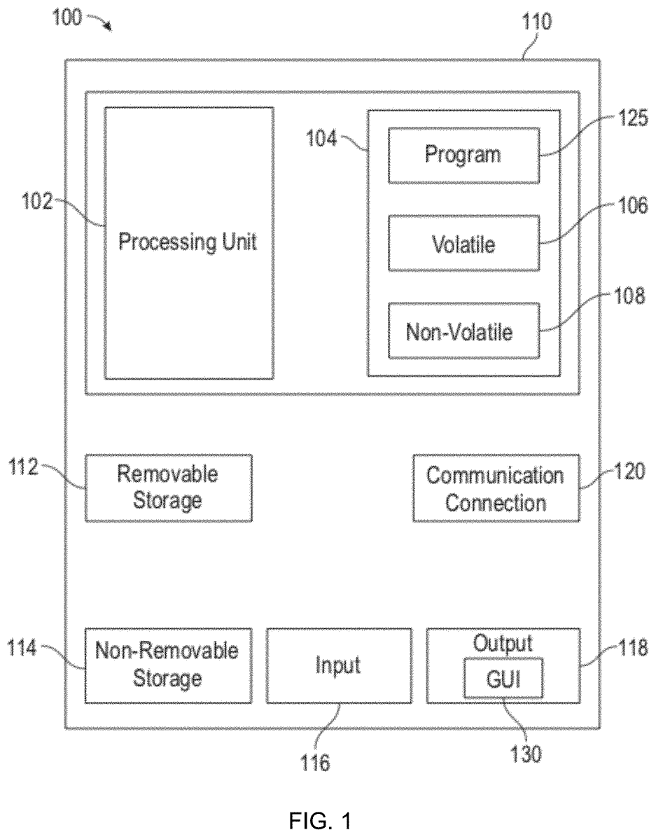

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

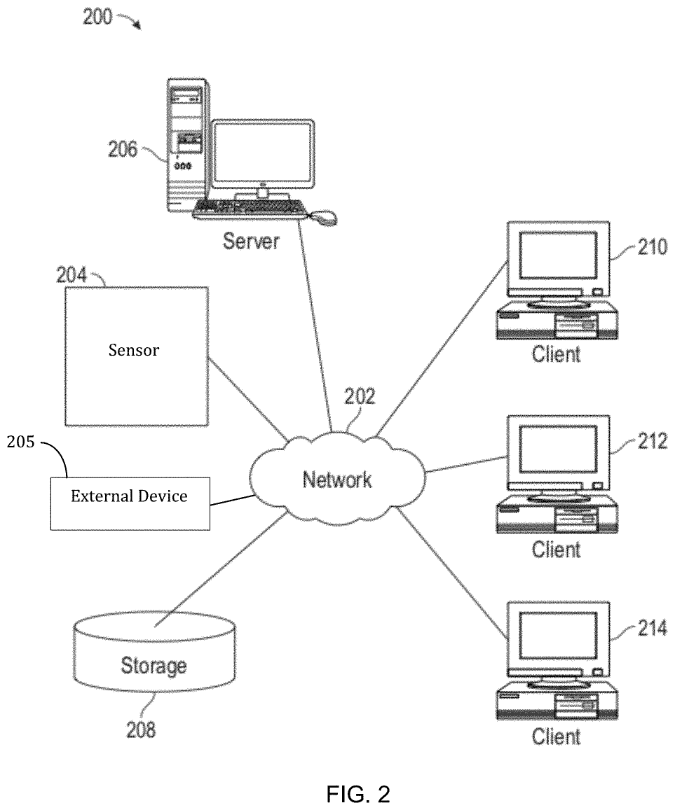

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. Network 202 may also be in communication with one or more RFID and/or GPS enabled devices or sensors 204, or other such external devices 205, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that external device 205 may be embodied as a mobile device, cell phone, tablet device, monitoring device, detector device, sensor microcontroller, controller, receiver, transceiver, or other such device.

In the depicted example, external device 205, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and RFID and/or GPS enabled device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

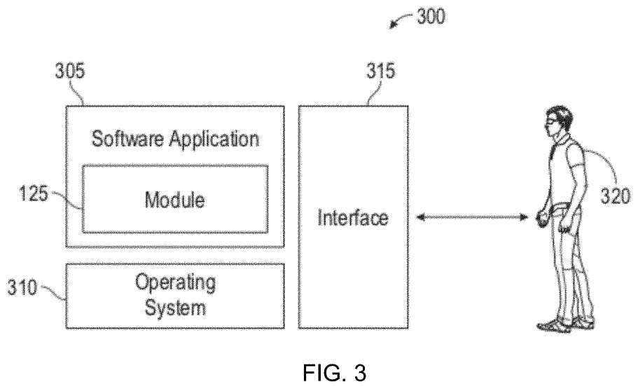

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

The embodiments disclosed herein can comprise at least two fantasy games, a first mode or “tailgate mode,” and a second mode or “FairWeather” mode. One or both of the game modes can be configured to involve a league. Both game modes operate using substantially similar game rules (e.g. a set lineup of a select number of players, from one team, head-to-head contests, points accumulated in a leaderboard, etc.).

In an exemplary embodiment, users can be prompted to sign up using a computer system or mobile application. Users are prompted to select their favorite team(s) in one or more sports leagues (for example professional or collegiate football, professional or collegiate baseball, professional or collegiate hockey, professional or collegiate soccer, etc.). Users can be required to select at least one team in at least one of the leagues, but in certain embodiments there is no limit to the number of selections of teams and/or leagues that can be made. The system can be configured to encourage and accept selection of as many teams as possible. Selections can be changed, increased, or decreased anytime from the “My Teams” section in the system.

The first mode, or “tailgate mode” allows users to select one team per league as their primary team. Players on the selected primary team can be used as a pool of players from which to set a lineup for each upcoming contest. The user can be subscribed to the selected teams' social media feed in the “news” section of the system. The same primary teams in each league can be used game-to-game to set lineups. Points in tailgate mode can be recorded in the tailgate-only scoreboard, in addition to the tailgate master/overall scoreboard which can be updated daily.

As an example, A Los Angeles resident may set a professional LA based basketball team, a professional LA based football team, A professional LA based hockey team, a professional LA based soccer team, and a professional LA based baseball team as their favorite teams to be used for Tailgate mode. The user has thus selected five teams that will be used in Tailgate mode.

The second mode or, “FairWeather” mode, allows users to set a lineup of a designated number of players (for example 3 players) for each of the teams selected, for each game, as specified in the My Teams section of the system. The user can set a lineup for every game in which the selected teams are involved. The user can also be subscribed to each team's social media feed in the “News” section of the system. The last step of the signup process requires the user to set the teams to be used for the Tailgate game mode. The Tailgate selection can be updated from the My Teams section in the app.

As an example, A Los Angeles resident may set two professional LA based basketball teams, two professional LA based football teams, A professional LA based hockey team, a professional LA based soccer team, and two professional LA based baseball teams. The user has thus selected eight teams that will be used in FairWeather mode.

All points accumulated in FairWeather mode will be recorded in the overall/Tailgate Master scoreboard which can be updated daily.

Users can sign up for leagues using the system. The league commissioner can set basic league parameters including league size, start dates, game mode (Tailgate or FairWeather), and invite the other participants in the league via email or text. If the league is in FairWeather mode, team owners can modify their selections any time before a game starts. In Tailgate mode the team can only be changed at the start of each league season, or as the league rules allow.

Leagues will run for a standard duration as set by the league commissioner or the system administrator. Head to head matchups can be set randomly, automatically, or by the league commissioner, between teams participating in the league. A win/loss record for each team in the league can be maintained based on the results of each head to head matchup, and points can be recorded for each of the participating teams. The league standings can be based on head to head record or total points, or some combination thereof. All points in league mode will be recorded in the overall/Tailgate Master scoreboard that is updated daily.

Leagues will include year-end playoffs to determine the champion. Two or more users in the league can participate in the tournament, and can be, for example, seeded by win/loss record first. If multiple teams have the same record, tiebreakers can be used. In certain embodiments, points for will be used as a tie-breaker (e.g., the league season can comprise a 13 week regular season for the NFL, followed by a 3 week playoff bracket that begins week 14 of the NFL season, if the league has 8 teams).

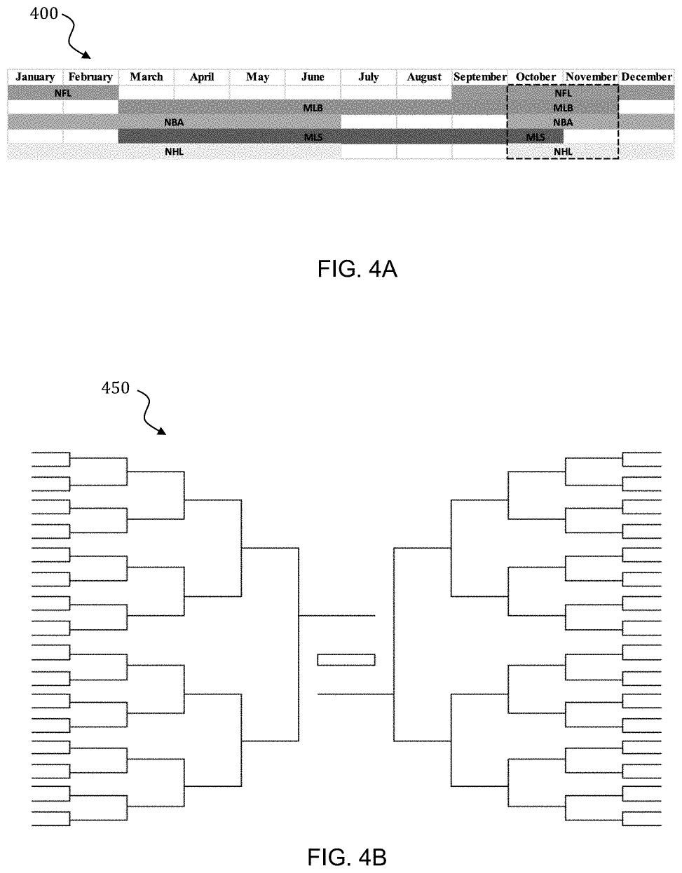

In certain embodiments, leaderboards can be maintained by the system. Leaderboards can include an overall leaderboard, FairWeather leaderboard, Tailgate leaderboard, and other such leaderboards. All points accumulated in FairWeather, Tailgate, and League mode will be added to the overall leaderboard. Only points earned in Tailgate mode will be added to the Tailgate leaderboard, etc. At the end of the Tailgate season, an elimination tournament can begin. A bracket 450 for such a tournament is illustrated in FIG. 4B. For example, the elimination tournament can comprise a 64-team, single elimination tournament between the players with the highest scores, for all leaderboards. This seven week tournament can be held during the peak of the sports calendar, with the most overlap in sports saturation among the leagues. Current sports league overlap is illustrated in chart 400. In certain embodiments, October 1st can be the start date as indicated chart 400 in FIG. 4A. The players who finish in 1st, 2nd, and 3rd will be featured in the system and can win prizes, awards, etc.

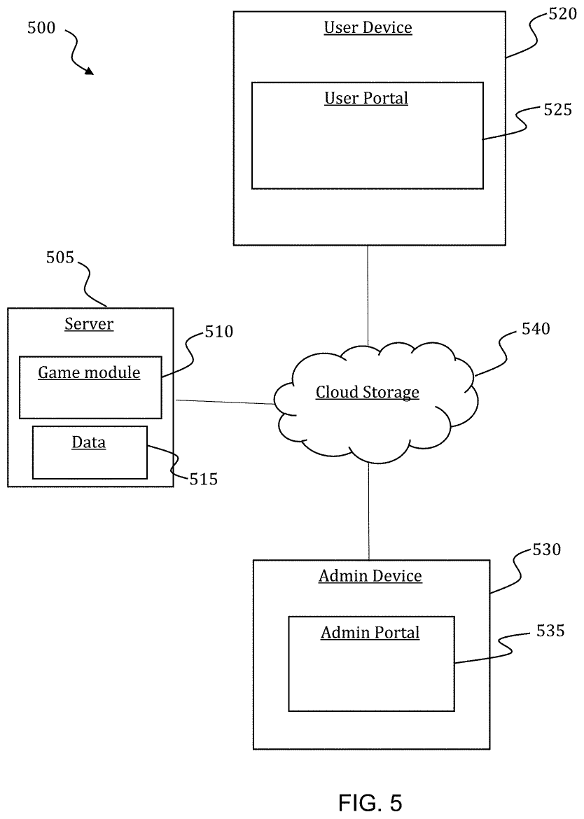

FIG. 5 illustrates a fantasy game system 500 architecture in accordance with the disclosed embodiments, the system 500 can generally comprise a server 505 which can store a game module 510, and data structures 515 for storing game data. Cloud storage 540 can also be used. The server 505 can be connected via wired or wireless data connections to a user device 520. The user device 520 can comprise a user mobile device, cell phone, computer system, tablet device or the like. The user device 520 can include a user portal 525 which generally includes a user interface and certain onboard software modules to run the game on the user device 520. In other embodiments, some or all aspects of the game can be provided as a web application, which can be accessed via the user device 520 using a standard web browser.

Likewise, the server 505 can be connected to an admin device. The admin device 530 can comprise an admin mobile device, cell phone, computer system, tablet device or the like. The admin device 530 can include an admin portal 535 which generally includes a user interface and certain onboard software modules that allow an administrator to control and modify aspects of the system 500 as necessary for the game to proceed. In other embodiments, some or all aspects of the admin portal can be provided as a web application, which can be accessed via the admin device using a standard web browser.

The aspects and embodiments of the systems and methods disclosed herein can be realized using the system 500 architecture illustrated in FIG. 5. The system 500 of FIG. 5 may further include aspects illustrated in FIGS. 1-3.

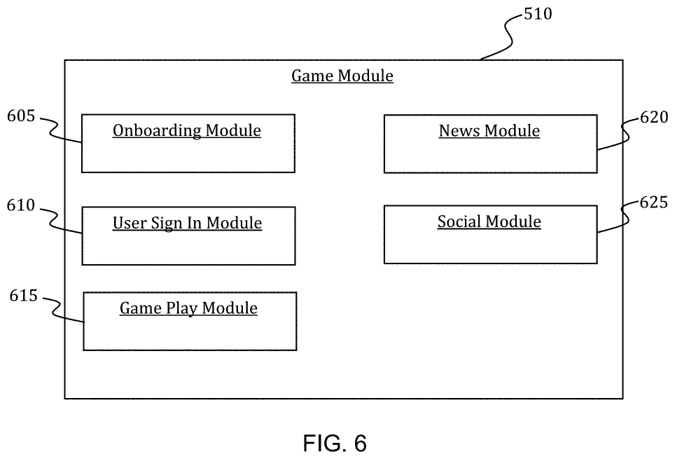

FIG. 6 illustrates a block diagram of submodules associated with the game module 510. The submodules can include an onboarding module 605, user sign in module 610, game play module 615, news module 620, and social module 625. Aspects of each of the modules are further detailed herein.

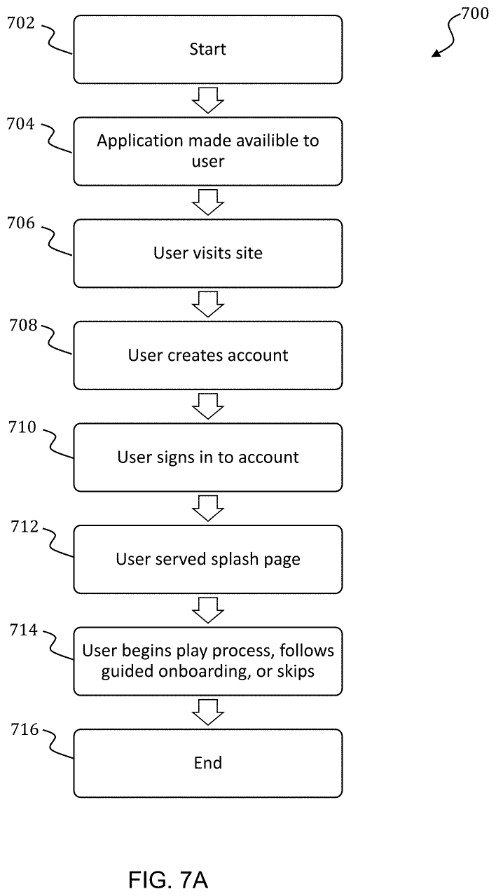

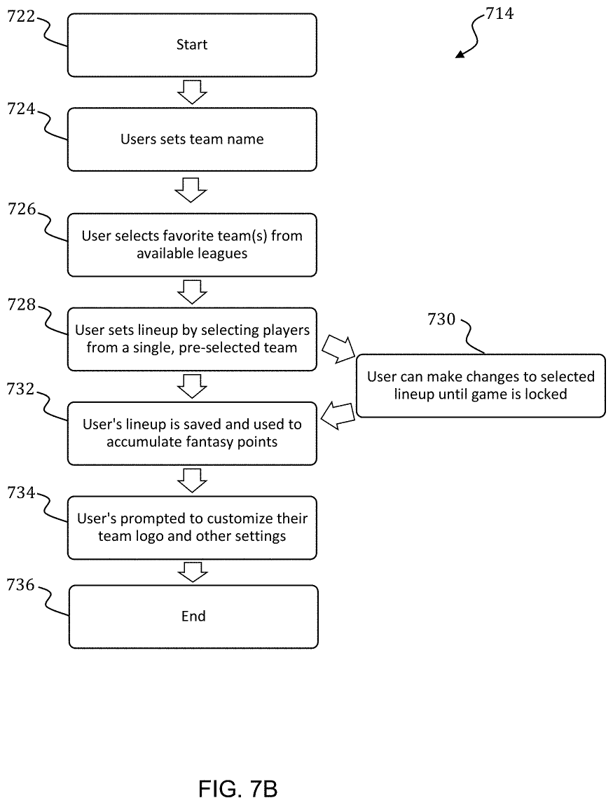

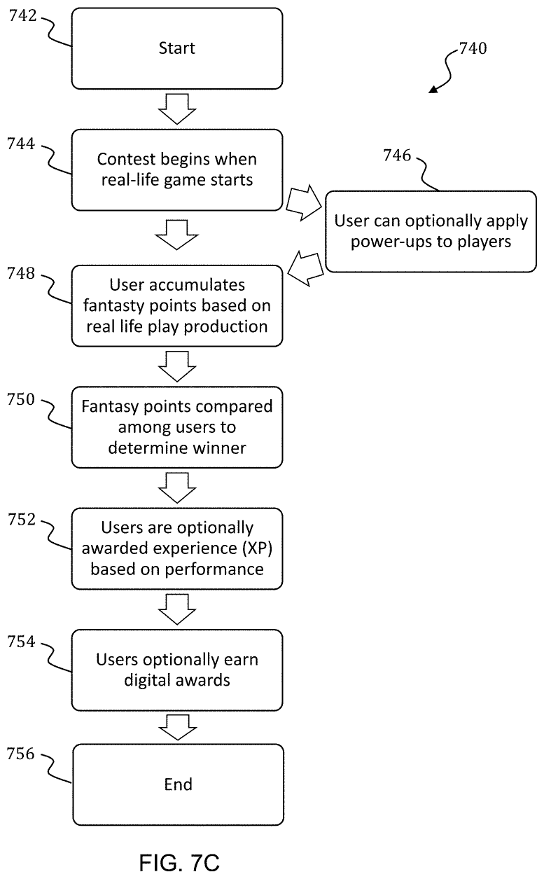

The onboarding module 605 can be used for onboarding new users to the system. Steps associated with a method 700 for onboarding are illustrated in FIG. 7A. Aspects of the method 700 can be implemented by the onboarding module 605. The method 700 starts at block 702.

As illustrated, the system can begin with a web application, downloadable application, desktop or mobile device made available to a user at block 704. This can be a result of organic search, and/or search engine optimization, lead pages, referrals, affiliates, social media, or other such digital traffic sources.

The user can visit a website served by the server at block 706. In order to on-board new users, the user can create a new account at block 708. The account can be created using a user's personal information, including but not limited to, first name, last name, email address, password, and/or favorite sports teams (pro and/or amateur). In certain embodiments, signup information can be optional or required as determined by the administrator. In certain embodiments, two-factor authentication can be used to confirm the account and user's identity (via email, text, etc.). Account information can be provided to the user's device, admin device, and or server as necessary to access data associated with the user.

Next, at block 710 the user can sign into their account. In certain embodiments, account information can be saved to skip or expedite the login step. Upon sign in, a splash page can be served at block 712, to the mobile application and/or webpage where the user has logged in. The splash page can feature a logo and allows the user to tap or click anywhere on the screen, mobile or desktop, to enter the game lobby.

Once the user enters the game lobby the guided onboarding can be initiated at block 714. The guided onboarding can be provided the first time a user begins the “play” process and is hidden after the user has successfully set their first few lineups; the number of lineups are determined by an administrator. The guided onboarding can provide the user game rules, can guide the user through the rules of the game, and/or aid their participation in their first round of play. The method ends at block 716.

The guided onboarding of block 714 can include a number of steps as illustrated in FIG. 7B. For example, at block 722 the guided onboarding can start. At block 724, the user can set a team name. The user can be prompted to enter alpha-numeric characters to set a unique team name, separate from the login information. This is saved for future use for contests, leaderboards and rankings, etc. and will help identify each user publicly in the system ecosystem. The user's team name can be modified at any time from the user's settings page.

At block 726 the user is prompted to select their favorite team(s). The user is prompted to select a favorite team from any available league; professional, amateur, or NCAA. Some users may have already entered this information during the signup process, in which case their favorite teams can be pre-selected. The favorite team(s) can be modified later in compliance with game rules as maintained by an admin.

Available leagues include but are not limited to the NFL, NBA, MLB, NHL, MLS, NCAA Football, NCAA Basketball, PGA/Golf, Nascar, eSports, WNBA, MMA, Boxing, NCAA and any other league, or professional sports organization, or amateur sports organization, that can be included in the database or supplied by a data feed provider.

A data feed can be provided internally or via a 3rd party service that provides statistical information and other metadata about games in real time. Stats provided by the data feed can be synced and saved via API integration to the system's servers and databases. The data can be redistributed via the server user portal, or admin portal as necessary for game play. Once the stats are synced and saved to the server, they can be used by the game module and the associated internal scoring system before being displayed to the user. The system infrastructure is not dependent on any single data feed provider, and the data feed provider can be easily modified at any time.

As an example of block 726 of the onboarding process, a user taps or clicks on NFL, selects the Baltimore Ravens as their favorite NFL team, and that selection is saved to use in the game. Then the user can tap or click MLB and select the Washington Nationals as their favorite MLB team. The user can repeat this process for as many leagues as are available, or the user can skip ahead to the next step.

At block 728, a lineup can be set. The user can be prompted to select players from a single team, or pre-selected favorite team, until the maximum number of “starting” players is reached. Starting players are players of any position and sport, whose real life statistical production contributes towards, but is not limited to, a user's fantasy points, overall score, leaderboards, win/loss record, and rankings in the system.

Fantasy points can be calculated based on real-life statistics that are added to, subtracted from, divided by, multiplied by, or by any other mathematical function or algorithm, by “x” rate, where “x” can be any number, positive or negative. Most often, the mathematical function will be a multiplier and the rate will be positive, as illustrated by equation (1).

FantasyPoints=RealStats*“x rate” (1)

Table 1: provides an exemplary scoring table

TABLE 1
Football scoring:

| | |
|---|---|
| Type | Points |

Offense

| | |
|---|---|
| Passing Yards | +0.04 per yard |
| Rushing Yards | +0.10 per yard |
| Receiving Yards | +0.10 per yard |
| Return Yards (Kick, Punt) | +0.10 per yard |
| Number of Receptions (PPR) | +1 point per reception |
| Rushing Touchdowns | +6 points |
| Receiving Touchdowns | +6 points |
| Passing Touchdowns | +4 points |
| Return Touchdowns (Kick, Punt, INT, | +6 points |
| Fumble, Block) | |
| Field goals | +1 point per 10 yards of distance |
| 2 Point Conversion (pass) | +2 points |
| 2 Point Conversion (run) | +2 points |
| 2 Point Conversion (reception) | +2 points |
| Interceptions thrown | −2 points per INT |
| Fumbles lost | −2 points per fumble lost |

Defense (team → D/ST)

| | |
|---|---|
| Sack | +3 point per sack |
| Interception (defense) | +5 points per INT |
| Forced Fumbles (defense) | +3 points |
| Fumble Recovery (defense) | +2 points per fumble |
| | recovery |
| Safety | +2 points |
| Tackle | +2 points |
| Block (Punt, FG) | +5 points |

IDP → Individual defensive player

| | |
|---|---|
| Tackles | +2.5 points per tackle |
| Assisted Tackles | +1 point per assist |
| Tackles for loss | +3 points |
| Sacks | +4 points per sack |
| QB Hits | +.5 points per hit |
| Forced Fumbles | +3 points per forced fumble |
| Fumble Recoveries | +5 points per fumble recovery |
| Interceptions | +5 points per interception |
| Blocked FGs | +5 points per blocked FG |
| Blocked Punts | +5 points per blocked punt |
| Safeties | +10 points per safety |
| Defensive Conversion Return (PAT) | +10 points |
| Defensive or Special Teams TD | +6 points |
| Return Yards | +.10 per yard |

Basketball scoring:

| | |
|---|---|
| Type | Points |

Offense

| | |
|---|---|
| Points Scored | +1 point per point scored |
| Rebounds | +1.2 points |
| Assists | +1.5 points |
| Turnovers | −1 point |

Defense

| | |
|---|---|
| Steal | +3 points |
| Block | +3 points |

Baseball scoring:

| | |
|---|---|
| Type | Points |

Offense & Hitting

| | |
|---|---|
| Single | +1 point |
| Double | +2 points |
| Triple | +3 points |
| Home Run | +4 points (add Run & RBI) |
| Run | +1 point |
| RBI | +1 point |
| Walk | +1 point |
| Stolen Base | +2 points |
| Caught Stealing | −1 point |

Defense & Pitching

| | |
|---|---|
| Win | +3 (entire staff) |
| Strikeouts (individual pitcher) | 0-5 = 0 points |
| | 6-7 = +1 point |
| | 8-9 = +2 points |
| | 10-12 = +3 points |
| | 13-15 = +5 points |
| | 16-19 = +7 points |
| | 20+ = +10 points |
| Earned Runs Allowed (individual pitcher) | 0 runs = +7 points |
| | 1 run = +5 points |
| | 2 runs = +3 points |
| | 3 runs = +2 points |
| | 4 runs = +1 point |
| | 5+ runs = 0 points |
| Hits + Walks Allowed (individual pitcher) | 0 = +20 points |
| | 1 = +16 points |
| | 2 = +12 points |
| | 3-4 = +8 points |
| | 5-7 = +4 points |
| | 8-10 = +2 points |
| | 11-12 = +1 point |
| | 13+ = 0 points |

Hockey scoring:

| | |
|---|---|
| Type | Points |

Skaters

| | |
|---|---|
| Goals | +3 points per goal |
| Assists | +2 points per assist |
| Shots on Goal | +0.5 points per shot on goal |
| Plus/Minus | +1 point |
| Blocks | +0.5 points per block |
| Power Play Goals/Assists | +0.5 points |
| Short-Handed Goals/Assists | +0.5 points |
| Shootout Goals | +0.2 points |

Goaltenders

| | |
|---|---|
| Win | +3 points |
| Goals Against | −1 point per goal allowed |
| Saves | +0.2 points |
| Shutouts | +2 points per shutout |

Soccer scoring:

| | |
|---|---|
| Type | Points |

All Players

| | |
|---|---|
| Goals | +10 points per goal |
| Assists | +6 points per assist |
| Shots | +1 point per shot |
| Shots on Goal | +1 point per shot on goal |
| Crosses | +0.75 points per cross |
| Fouled | +1 point |
| Fouls | −1 point |
| Tackles Won | +1 point |
| Interceptions | +0.5 points |
| Yellow Cards | −1.5 points per yellow card |
| Red Cards | −3 points per red card |
| Penalty Kick Miss | −5 points per PK miss |

Defense & Goalkeeper

| | |
|---|---|
| Clean Sheets/Shutout | +5 points (entire team) |
| Goalie Saves | +2 points per save |
| Goals against | −2 points per goal allowed |
| Win | +5 points |
| Penalty Kick Saves | +3 points per PK save |

It should be noted that these scoring templates are exemplary and other scoring tables can be used in other embodiments. The scoring table can be saved on the server, or client device. As live action events occur, the server or client device can tabulate scores based on the scoring table, for each player and each team involved in the game. Real time or near real time scoring updates can be provided to the client device via the client portal so that the player can see their score and the score of other players.

A “starting lineup” can comprise of any number of players, 0 players (or an entire real-life team), to the maximum number of players available on a real-life roster, regardless of sport, at any given time. In certain embodiments, a starting lineup can comprise three players from a single team only; whether a pre-selected favorite team, or the user selects a team before each contest. The number of starting players can be modified at any time per the rules of the game as illustrated by block 730.

In certain embodiments, users can have the same starting lineups for multiple contests, or they can be required to rotate any number of players as specified by the administrator in the game rules. The number of players a user must rotate can be changed at any time at the admin's discretion, to aid in providing competitive balance. Site-enforced player rotation will assist in creating parity among user's final scores and win/loss records. More player rotations will result in a greater number of unique scores among users. Users must swap two of the three starters with players who were not selected in the previous contest.

In an embodiment, the player rotation rule can include one “favorite” player, where other players are swapped out. Users can edit their lineup selection and save the changes anytime, up until a game is “locked” in the system, or thereafter, per the admin set official rules. A game is considered locked at the start of a real life contest, or as determined by the data feed provider and/or the system. The site-enforced “lock rule” can be modified at the admin's discretion, and there can be exceptions. Exceptions can include, but are not limited to, game and weather delays, postponed contests, or powerups users can purchase and use to swap players after games have been locked.

After the guided onboarding (or if a user selects to skip certain onboarding aspects), the user's player selections are saved to form a starting lineup as illustrated at block 732. Each player that is part of the starting lineup will contribute toward a user's fantasy points, and the fantasy points will be used in a variety of ways, including, but not limited to, leaderboards, win/loss records, rankings, stats and research and their overall score.

In certain embodiments, users can customize their team and settings in a profile section as illustrated at block 734. In the profile section, users can upload a picture to use for their team's photo, or choose a pre-selected image. They can also change their team name, update their favorite team(s), or change various site settings including login email address, password, etc. The method ends at block 736.

In game play is illustrated by method 740, illustrated in FIG. 7C. The method 740 begins at block 742. The contest can begin when the real-life games start as illustrated at block 744. User's accumulate fantasy points based on real life play product as illustrated at block 748. The fantasy points are compared against those of a head to head participant, or a league of other participants to determine a ranking and winner as illustrated at block 750.

Regarding the win/loss record, the system will maintain a record of wins and losses for each user. Wins and losses will be determined by whichever team scores more fantasy points over a period of time, typically one real-life game, although other game periods are possible. Users can play head-to-head and earn wins and losses versus another human opponent, artificial intelligence or a bot opponent, or against site administrators who set lineups on behalf of the system.

The system can further maintain leaderboards, showing user's fantasy scores over a period of time. Example leaderboards include but are not limited to, all users and their lifetime scores, “featured” leaders such as top 100 or top 50 users, leaders by sport, leaders by pro or amateur league, leaders by game-type, etc. A search bar can be included to help users locate their team and friends by name or email address.

The system can use fantasy scores to assign a ranking number to users. The rankings will identify and showcase the top all-time users, and will be shown in various places within the game. Rankings go from number one to as many users are signed up for the game, with number one being the best user determined by overall score.

Statistical data and research functionality can also be provided by the system. Fantasy points and other stats will be stored and saved in various places throughout the game. For example, a user may require access to historical stats to make informed decisions about which players to use, and how to set their lineups. Statistics in general are helpful to fantasy players. Historical statistics may be used for projection algorithms (proprietary or provided by a data feed provider), machine learning, graphs, awards, and user milestones. Historical data can also include other non-statistical items such as gambling lines, over/under, or anything else a data feed provider can provide to the database.

In certain embodiments, users can also form leagues with other users. Each league can have its own leaderboard, win/loss record, playoffs, and commissioner. The league commissioner will have additional options, including but not limited to, inviting other players to join the league, send and receive league entry fees, send and receive earnings to other players, setup their league's internal scoring system, make manual stat corrections, etc. Leagues can be active for an entire calendar year, a single sports season, or the official season defined by the system admin.

Users can check their team's score with the user module when a contest is in progress. Play-by-play updates can be provided as real scores and are updated by the data feed, preferably as close to real-time as possible. Play-by-play updates can include any game-related data, play synopsis, box scores, and data and play visualization. A user can also see how their fantasy team is doing against another user, both in and out of league mode. Users can post to chat boards and interact with other users who are interested in, or following the same contest.

In certain embodiments, users can upgrade to a “pro” or ad-free version of the game, for example, by paying a fee. A “pro edition” can include extra game modes or features, limited to paid users only, and a paywall can be setup to exclude non-paying users. For example, a free user can only use one team in each league, but a paid user could set unlimited lineups, not limited to any one team, or, in certain embodiments, leagues could be a paid feature, etc.

Users can accumulate experience (or XP), after playing in contests or reaching certain milestones as illustrated at block 752. XP can be used in a variety of ways, but particularly for setting “levels.” For example, a user starts at level zero, and when they win a contest they earn 100 XP. The 100 XP can be added to the user's existing XP balance, and this process can be repeated until they reach the threshold to achieve the next “level” (level one in this example).

Likewise, users can earn awards, gifts, badges, trophies, milestones, and other perks, digital or tangible, to be used in or during game play as illustrated at block 754. Perks can be earned on a recurring basis, or based on performance. For example, a user opens a daily gift of 1000 XP when they open the app, or can be given an award by the system for winning 5 consecutive games. Awards can be saved in the user's profile by the system.

In certain embodiments, the system can offer in-app currency to be used in a variety of ways, including but not limited to, power-ups and abilities, merchandise, special events, stat escalators, etc. as illustrated at block 746. Similar to XP, currency can be earned and accumulated daily or based on performance. Users can purchase in-app currency in exchange for real currency (US dollars). For example, a user purchases 1000 in-app coins for one real dollar. The in-app coins can then be used to buy a power-up to earn 1.5× more points per starting player, or perhaps to swap out a player who has already been “locked” etc. In-app coins will not be acceptable anywhere outside of the system and in certain embodiments cannot be re-exchanged or returned.

In certain embodiments, users can pay an entry fee to participate in specific contests or tournaments with a chance to win money or other prizes. In certain embodiments, this can include users selecting players assigned various values and must stay under a designated cap, with the top scoring users earning the largest share of the total prize pool. These games are considered games of skill.

In certain embodiments, the system can also provide game methods to be used for charity/educational purposes, such as mathematics. A version of the system can be provided to schools and/or school districts with predetermined curriculum to use alongside the app. Students can use the app over a semester with curriculum getting more advanced and building upon lessons over the course of time. Students can take exams and earn certificate(s) of completion from the system, with a goal of increasing math fluency and participation in class. NCAA athletics can also be featured as a way to increase student's interest in post-secondary institutions. The method ends at block 756.

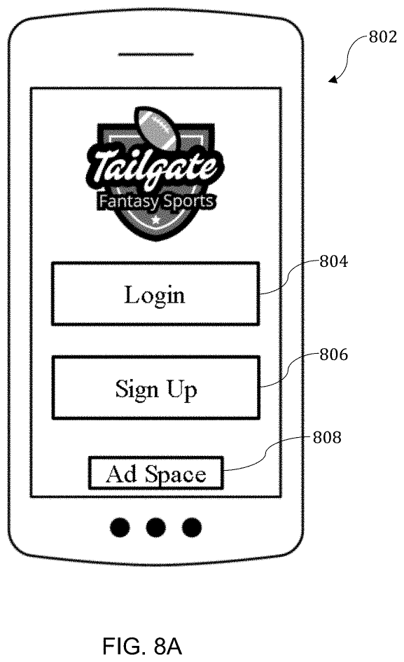

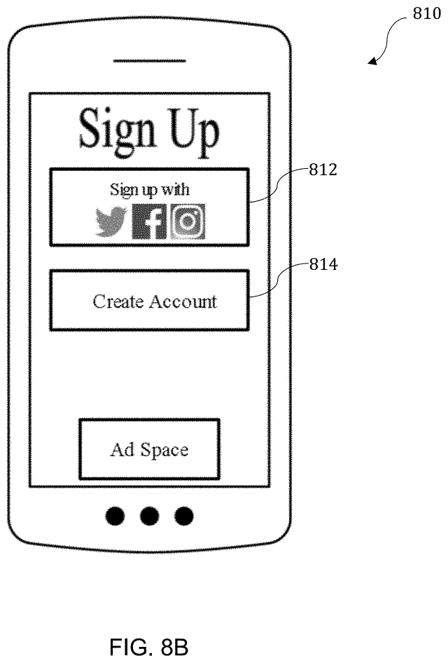

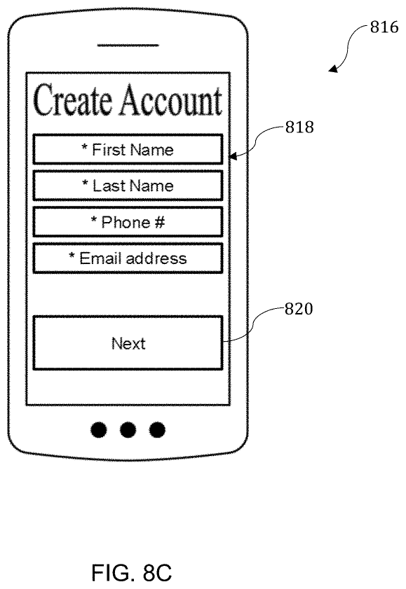

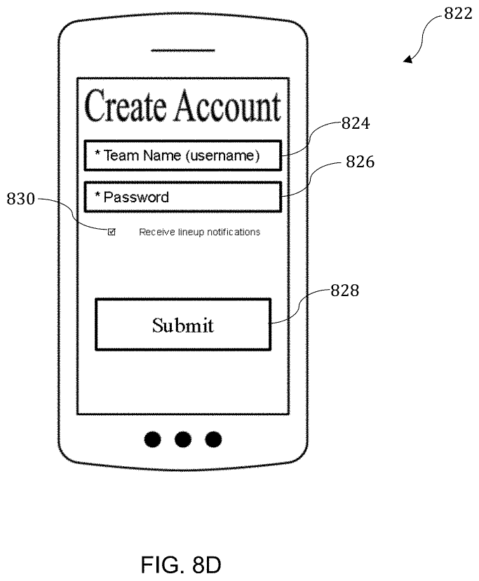

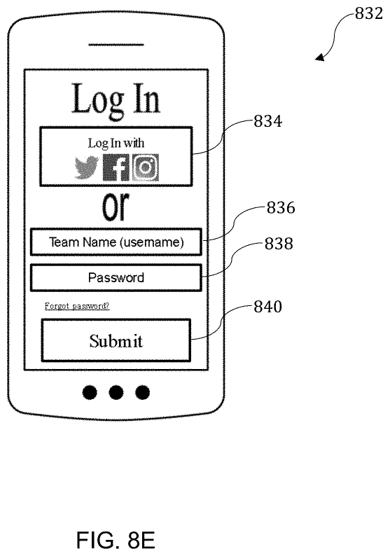

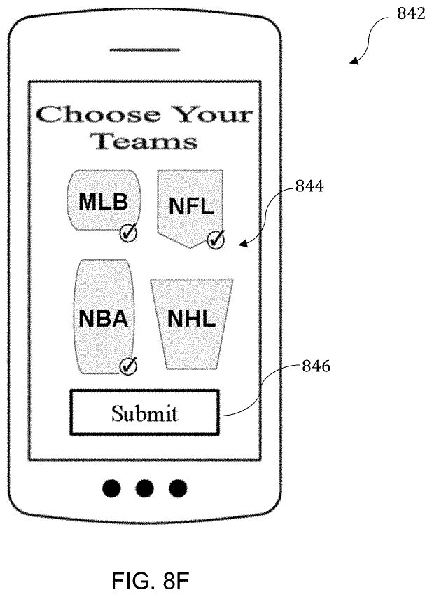

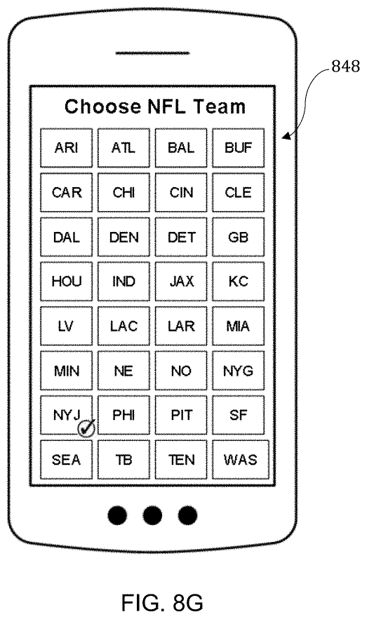

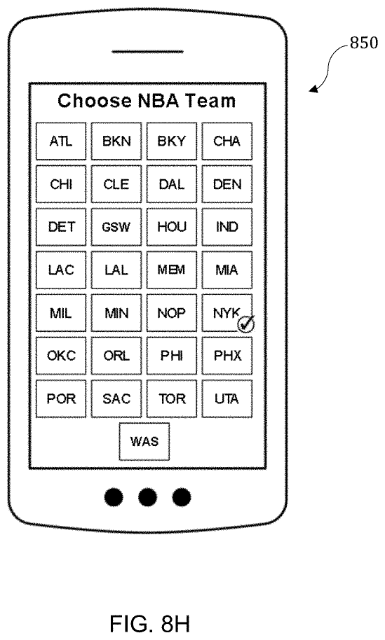

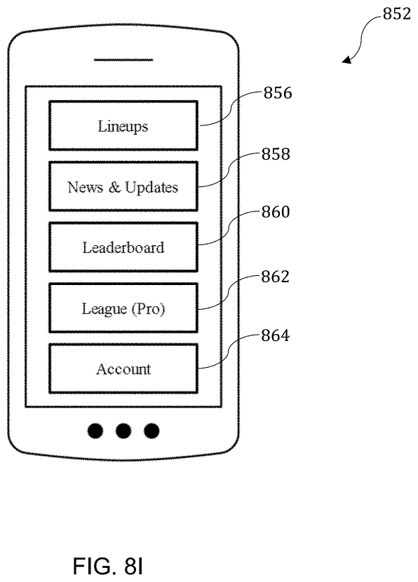

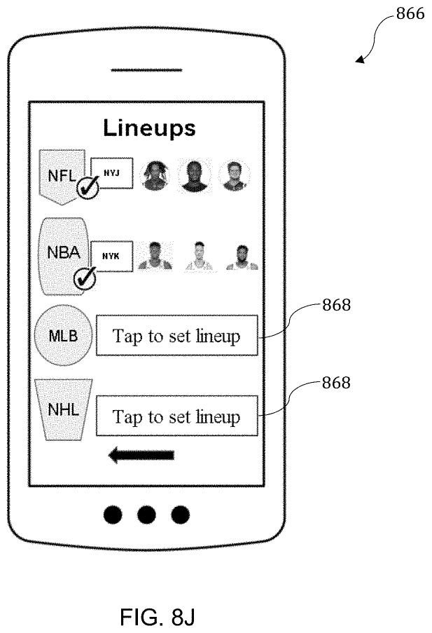

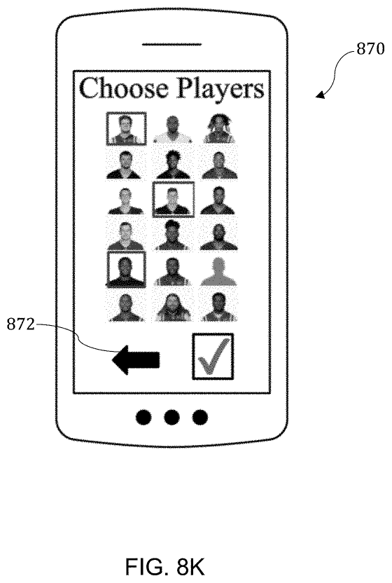

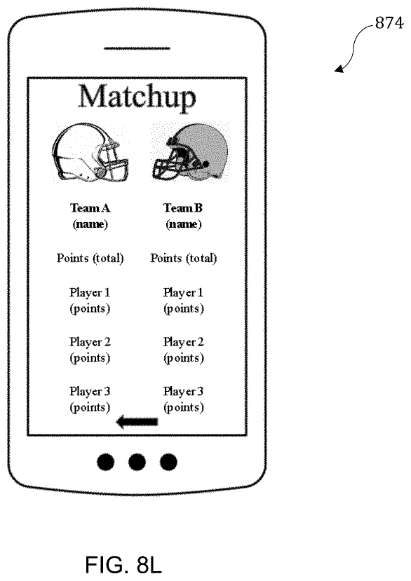

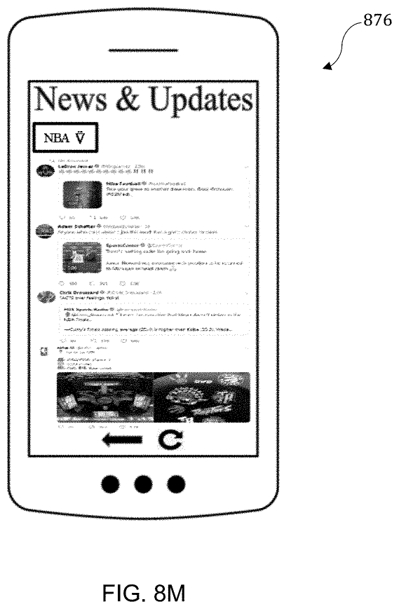

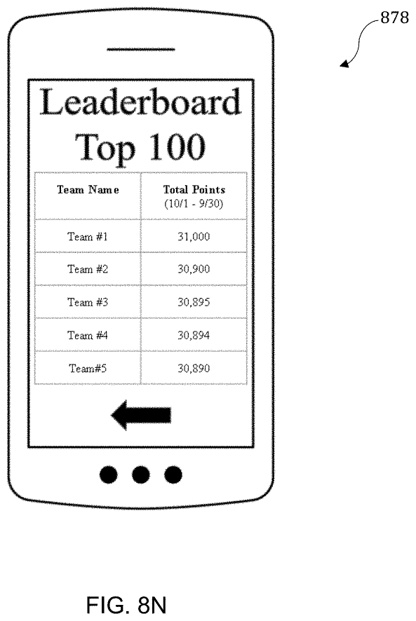

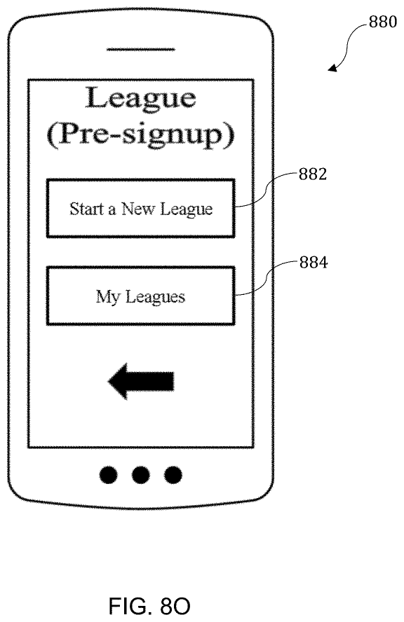

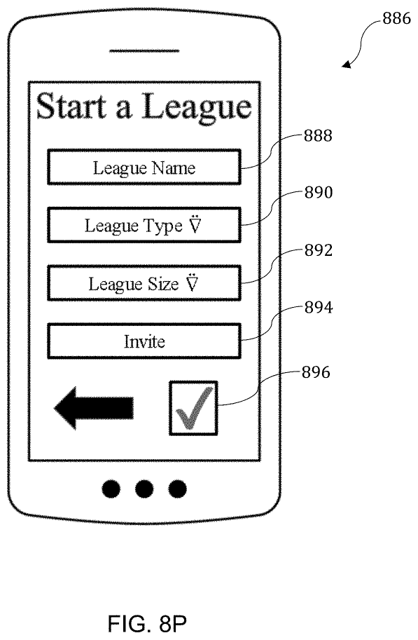

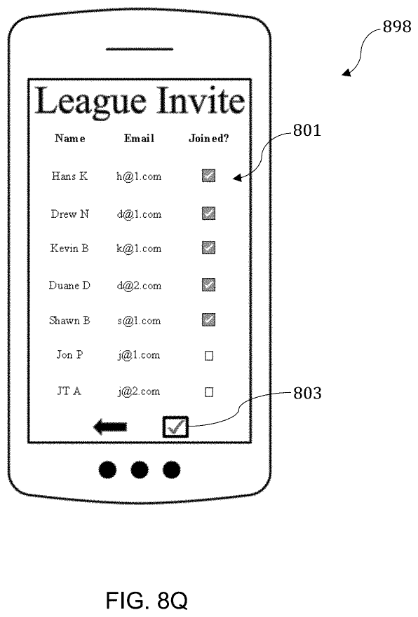

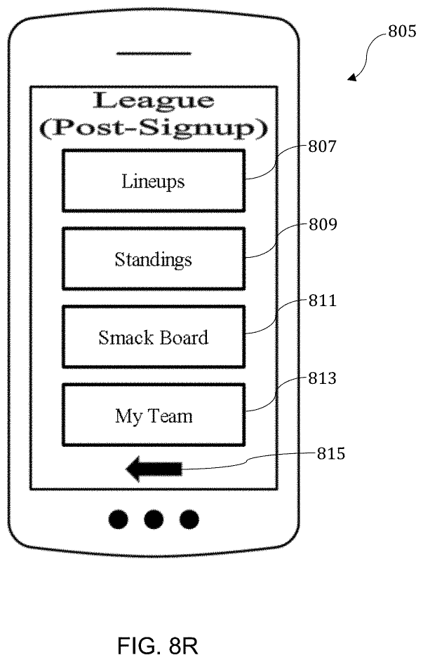

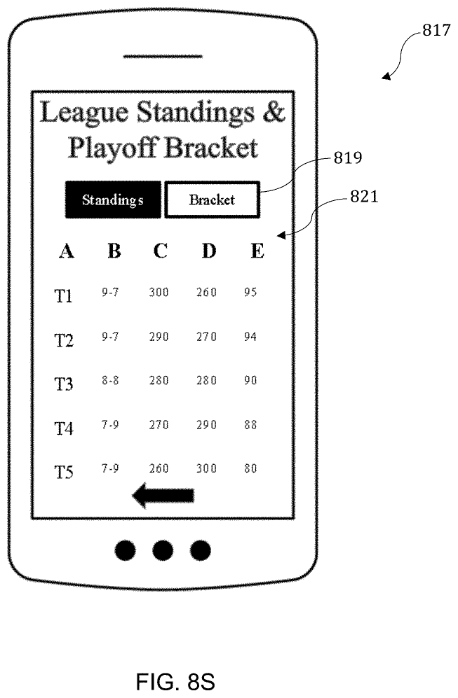

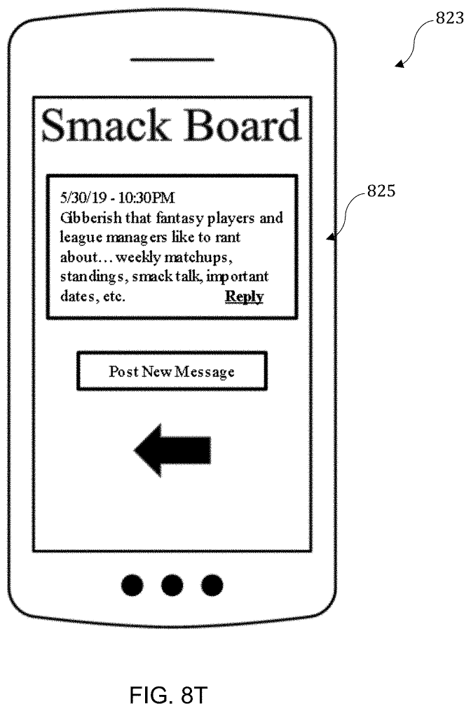

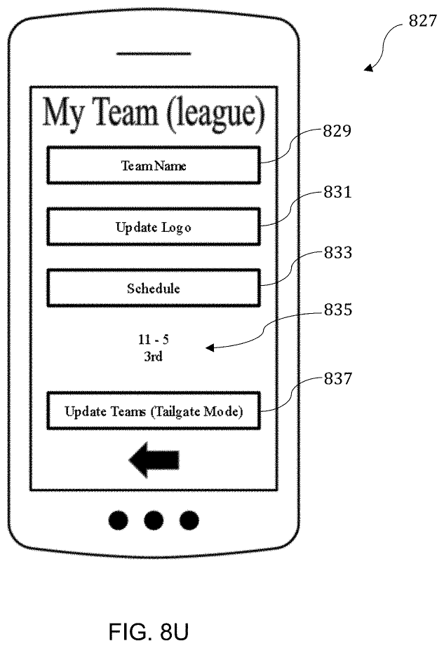

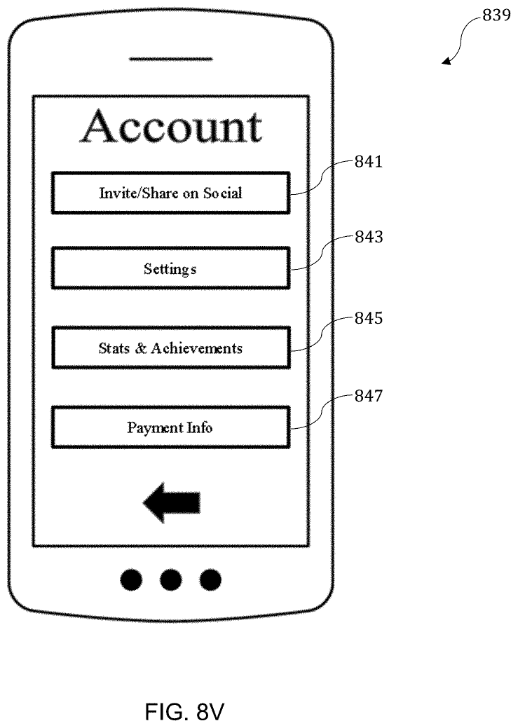

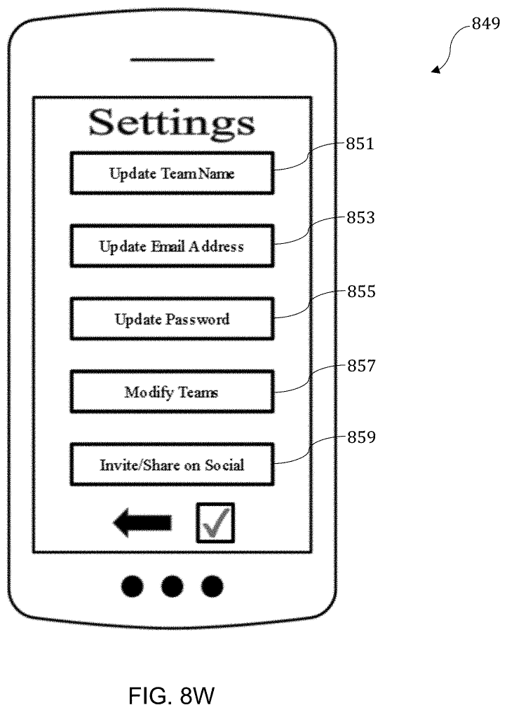

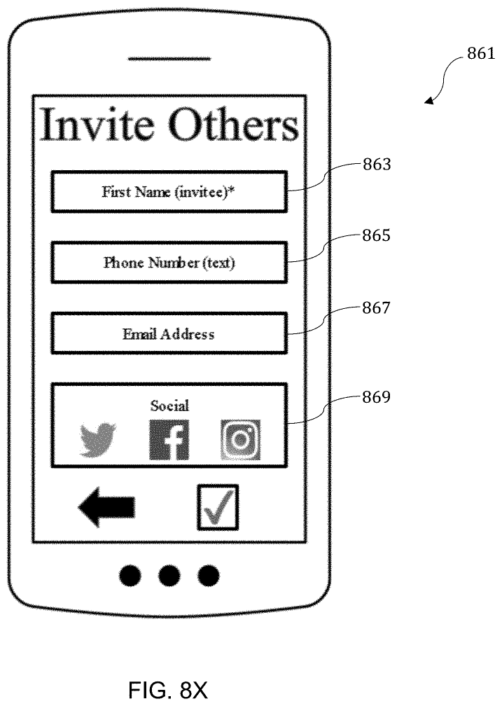

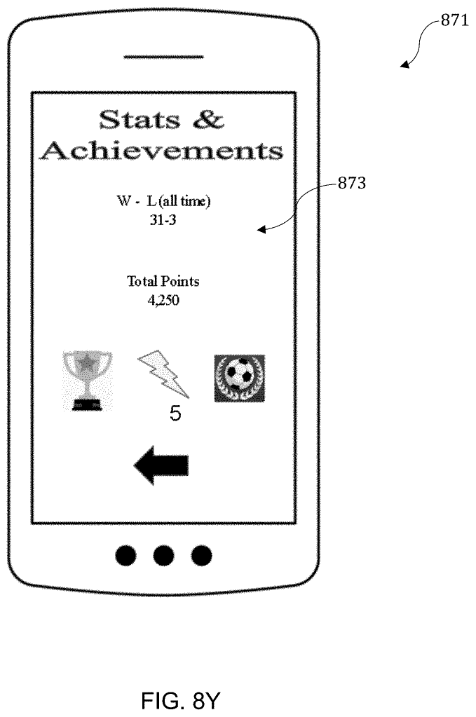

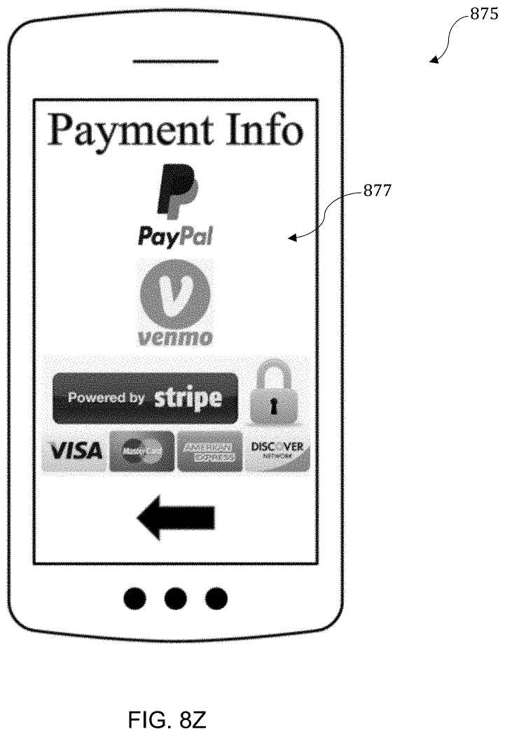

FIG. 8A-8Z illustrates exemplary software implementations and associated process flows associated with fantasy sports and fantasy games based on real word statistics and statistical projections. The figures provide, exemplary interfaces associated with a user device and associated user module, along with exemplary workflow, in accordance with the disclosed embodiments. It should be appreciated that the exemplary embodiments shown in FIGS. 8A-8Z are provided as aspects of a mobile application served on a mobile device but in other embodiments, similar workflow served to other computer systems or devices are also possible.

As illustrated at workflow 802 in FIG. 8A, a login option 804 can be provided, along with a signup option 806. Additional advertisement space can be provided at the bottom of the interface. The Login 804 can advance the interface to a login page. The signup button 806 can advance the system to a signup page. Ad space 808 can be provided in the workflow 802.

At workflow 810 the signup page is illustrated in FIG. 8B. The user can be prompted to sign up using various other platforms with button 812, or the user can operate a button 814 to create a new account. As illustrated in FIG. 8C, at workflow 816, the user can enter their name, phone number and email address in data fields 818. Once this information is entered, the interface will activate a button 820 to advance to the next page.

At workflow 822, illustrated in FIG. 8D, the user can create a team name in field 824, which can also serve as a team name. The system can verify the username is not taken. The user can also provide a secure password in field 826. When these fields are properly populated, the interface will activate a button 828 to submit the information. A lineup notification checkbox 830 can be provided which allows the user to receive push notifications related to their lineup.

Workflow 832 in FIG. 8E, illustrates the circumstance where the user already has an account and has landed on a login page. At this interface, the user can login using a connection to a social media account at 834, or can enter their previously stored team name (username) at field 836 and password at field 838. The interface can include a button 840 to submit the information.

Once the user is logged in, the system advances to workflow 842 illustrated in FIG. 8F. Workflow 842 allows the user to select their various leagues or sports as illustrated at 844. As previously disclosed, this can include, but is not limited to, professional or collegiate football, baseball, basketball, soccer, hockey, golf, tennis, vehicle racing, and the like. The system can validate selections with highlighting, checkboxes, or other such indicators 844. The system can validate the selection with button 846. At workflow 848 in FIG. 8G and workflow 850 at FIG. 8H, the user can further select teams from the selected leagues. The leagues illustrated are exemplary, and can include football leagues, basketball leagues, baseball leagues, soccer leagues, hockey leagues, and other such sports leagues.

Workflow 852 in FIG. 8I illustrates a home page once initial input data is provided. The home page can include a lineups button 856 which advances to a lineups page, a news and updates button 858 that advances to a news/social feed page, a leaderboards button 860 which advances to an overall leaderboard page, a league button 862 that advances to a league home page, and an account button 864 which advances to a user's account page.

Workflow 866 in FIG. 8J illustrates a lineup page. At the lineups page a current lineup for a given league or leagues can be provided. A league can be selected from this page so that the lineup associated with that particular league can be modified with button 868. This is illustrated at workflow 870 in FIG. 8K. For leagues where a lineup hasn't been set, the screen can include a prompt to set the lineup. The lineup page can further include a back button 872 to return to the previous workflow.

The lineups workflow 870 can allow a user to select players. Selected players can be highlighted, boxed, or otherwise identified. Once the desired players are selected, the lineup can be submitted.

Workflow 874 in FIG. 8L, illustrates a matchup page illustrating a weekly heads up matchup between two teams. The matchups page shows team names and logo, along with point totals for one or more players on each of the respective teams. The workflow can further include a back button to return to the previous page.

Workflow 876 in FIG. 8M, illustrates a news and updates page. This can include social media and news feeds providing information relevant to the sports and teams the user has selected. The news and updates page can further include a back button to return to the previous page.

Workflow 878 in FIG. 8N, illustrates a leaderboard page. The leaderboard page can include a sortable list of teams. The default sort can be in order to total points. The leaderboard page can further include a back button to return to the previous page.

Workflow 880 in FIG. 8O illustrates a league pre-signup page. The league pre-signup provides a button 882 to advance to a page where a new league can be configured, along with a button 884 to advance to a leagues page. The league pre-signup page can further include a back button to return to the previous page.

Workflow 886 in FIG. 8P illustrates a league sign up page. The league sign up page includes fields to indicate a league name 888, league type 890, and league size 892. The workflow also includes a button 894 to advance to an invitation screen. The workflow further includes submit button 896 and a back button to return to the previous page.

Workflow 898 in FIG. 8Q illustrates a league invite page. The league invite page can include a list of names, along with associated email addresses, and an indicator 801 of whether or not the person has joined the league. The league invite page can further include a submit button 803 which sends invitations to members on the list to join the league. The league invite page can further include a back button to return to the previous page.

The workflow 805 in FIG. 8R can include a league home page, post sign up. The league home page post sign up can include a lineups button 807 that advances to a lineups page, a standings button 809 that advances to a standings page, a smack board button 811, that advances to a smack board, a my team button 813 that advances to a my team page, and a back button 815 to return to the previous page.

The workflow 817 in FIG. 8S can further include a current standings page in league mode. The current standings page includes a standings/bracket toggle button 819 that toggles the screen between the current league standings and the playoff bracket, as well as a project or real playoff bracket. The page can further provide data labels 821 indicative of various team data including team name, win/loss record, points for, points against, average points, and +/−points for and against. The current standings page can further include a back button to return to the previous page.

The workflow 823 in FIG. 8T, can include a smack board page. The smack board page can include a field 825 where users can post comments, and where other user's comments are made visible. The smack board page can further include a back button to return to the previous page.

The workflow 827 in FIG. 8U, can include a my team page. The my team page can allow a user to submit or modify data associated with the team. For example, the my team page can include a team name button 829 that advances to a page where the team name can be changed. The logo button 831 that advances to a page where the logo can be changed. The user can choose from a small variety of stock logos or the user can upload a custom file. A schedule button 833 can be provided which advances to a league schedule page. A field 835 can indicate the teams win loss record. The update teams button 837 can further be provided (or can be hidden) that advances to a team selection landing page. This is only visible if the league is in tailgate mode. The my team page can further include a back button to return to the previous page.

The workflow 839 in FIG. 8V can include an accounts page. The accounts page can include an invite/share button 841 that advances to a referral page. The settings button 843 can advance to a settings page. The stats & achievements button 845 can advance to a stats & achievements page. The payment info button 847 can advance to a payment information page. The accounts page can further include a back button to return to the previous page.

Workflow 849 in FIG. 8W can include a settings page. The settings page can include an update team name button 851, which advances to a page where team name can be changed. The settings page can further include a button 853 that advances to a page where the email address associated with the account can be changed. The settings page can include an update password button 855 that advances to a page where a password can be reset. The modify teams button 857 can advance to a team selection landing page where teams can be changed. The invite/share button 859 advances to a referral page. The settings page can further include a back button to return to the previous page.

Workflow 861 in FIG. 8X can include a referral page. The referral page can include fields to enter an invitee's name 863, phone number 865, and email address 867. A social button 869 can advance to a pare where pre-filled social media post can be broadcasted to a player's social media networks. The referral page can further include a back button to return to the previous page.

Workflow 871 in FIG. 8Y can include a user stats and achievements page. The page can include labels 873 displaying a user's wins and losses, as well as total points. In certain embodiments, achievement badges can be awarded for various in game achievements. Achievements badges can be configured as buttons and can advance to a screen providing information about the achievement associated with the badge. The user stats and achievements page can further include a back button to return to the previous page.

Workflow 875 in FIG. 8Z can include a payment information page. The payment information page can include various buttons 877 provided to advance to associated payment authorization pages to pay for and/or authorize recurring charges. The payment information page can further include a back button to return to the previous page.

Based on the foregoing, it can be appreciated that a number of embodiments, preferred and alternative, are disclosed herein. In an embodiment, a system for fantasy games comprises a computer system further comprising: at least one processor; a graphical user interface; and a computer-usable medium embodying computer program code, the computer-usable medium capable of communicating with the at least one processor, the non-transitory computer program code comprising instructions executable by the at least one processor and configured for: defining a fantasy team, the fantasy team comprising multiple real world players selected from a single real world team, collecting sports data, assigning fantasy points to the fantasy team based on the sports data of the real world players selected from the single real world team, and summing the fantasy points for all the fantasy team into a fantasy score.

In an embodiment, the non-transitory computer program code comprising instructions executable by the at least one processor is further configured for comparing the fantasy score of the fantasy team to a second fantasy score of a second fantasy team, and identifying a winner based on which of the fantasy team and the second fantasy team have a higher score. In an embodiment, the non-transitory computer program code comprising instructions executable by the at least one processor is further configured for maintaining a leaderboard of the fantasy team, the second fantasy team, and additional fantasy teams.

In an embodiment, the multiple real world players comprise three real world players. In an embodiment, the non-transitory computer program code comprising instructions executable by the at least one processor is further configured for requiring the substitution of at least one of the three real world players for at least one other real world player from the same team between each game of the real world team. In an embodiment, the non-transitory computer program code comprising instructions executable by the at least one processor is further configured for designating one player on the real world team as a permanent member of the fantasy team, that is not required to be substituted.

In an embodiment, the non-transitory computer program code comprising instructions executable by the at least one processor is further configured for defining the fantasy team, as three real world players selected from a single real world team for each of a plurality of sports. In an embodiment, the plurality of sports comprise at least two of professional football, collegiate football, professional baseball, collegiate baseball, professional basketball, collegiate basketball, professional soccer, collegiate soccer, professional hockey, and collegiate hockey.

In an embodiment, the non-transitory computer program code comprising instructions executable by the at least one processor is further configured for awarding experience points according to the fantasy team performance. In an embodiment, the non-transitory computer program code comprising instructions executable by the at least one processor is further configured for awarding digital awards according to the fantasy team performance.

In another embodiment, a system for fantasy games comprises a computer system further comprising: at least one processor; a graphical user interface; and a computer-usable medium embodying computer program code, the computer-usable medium capable of communicating with the at least one processor, the non-transitory computer program code comprising instructions executable by the at least one processor and configured for: defining a plurality of fantasy teams, each of the plurality of fantasy teams comprising three real world players selected from a single real world team, collecting sports data comprising statistical data associated with the real world players, assigning fantasy points to each of the plurality fantasy teams based on the sports data, maintaining a leaderboard of the plurality of fantasy teams based on the fantasy points assigned to each of the plurality of fantasy teams.

In an embodiment, the non-transitory computer program code comprising instructions executable by the at least one processor is further configured for requiring the substitution of at least one of the three real world players for at least one other real world player from the same team between each game of the real world team. In an embodiment, the non-transitory computer program code comprising instructions executable by the at least one processor is further configured for defining the fantasy team, as three real world players selected from a single real world team for each of a plurality of sports.

In another embodiment, a computer implemented fantasy game method comprises defining a first fantasy team, the first fantasy team comprising multiple real world players selected from a single real world team, defining a second fantasy team, the second fantasy team comprising multiple real world players selected from a single real world team, collecting sports data, assigning fantasy points to the first fantasy team based on the sports data of the real world players selected from the single real world team to establish a first fantasy team score, assigning fantasy points to the second fantasy team based on the sports data of the real world players selected from the single real world team to establish a second fantasy team score, and identifying a winner between the first fantasy team and the second fantasy team by comparing a the first fantasy team score and the second fantasy team score.

In an embodiment, the multiple real world players comprise three real world players. In an embodiment, the method further comprises requiring the substitution of at least one of the three real world players for at least one other real world player from the same team between each game of the real world team.

In an embodiment, the method further comprises defining the fantasy team, as three real world players selected from a single real world team for each of a plurality of sports. In an embodiment, the plurality of sports comprise at least two of professional football, collegiate football, professional baseball, collegiate baseball, professional basketball, collegiate basketball, professional soccer, collegiate soccer, professional hockey, and collegiate hockey.

In an embodiment, the method further comprises awarding experience points according to the fantasy team performance. In an embodiment, the method further comprises awarding digital awards according to the fantasy team performance.

It should be appreciated that variations of the above-disclosed and other features and functions, or alternatives thereof, may be desirably combined into many other different systems or applications. It should be understood that various presently unforeseen or unanticipated alternatives, modifications, variations or improvements therein may be subsequently made by those skilled in the art which are also intended to be encompassed by the following claims.

What is claimed is:

1. A system for fantasy games comprising:
a computer system further comprising:
at least one processor;
a graphical user interface; and
a computer-usable medium embodying non-transitory computer program code, the computer-usable medium capable of communicating with the at least one processor, the non-transitory computer program code comprising instructions executable by the at least one processor and configured for:
defining a fantasy team, the fantasy team comprising multiple real world players selected from a single real world team;
collecting sports data;
assigning fantasy points to the fantasy team based on the sports data of the real world players selected from the single real world team; and
summing the fantasy points for all the fantasy team into a fantasy score.

2. The system for fantasy games of claim 1 wherein the non-transitory computer program code comprising instructions executable by the at least one processor is further configured for:
comparing the fantasy score of the fantasy team to a second fantasy score of a second fantasy team; and
identifying a winner based on which of the fantasy team and the second fantasy team have a higher score.

3. The system for fantasy games of claim 2 wherein the non-transitory computer program code comprising instructions executable by the at least one processor is further configured for:
maintaining a leaderboard of the fantasy team, the second fantasy team, and additional fantasy teams.

4. The system for fantasy games of claim 1 wherein the multiple real world players comprise three real world players.

5. The system for fantasy games of claim 4 wherein the non-transitory computer program code comprising instructions executable by the at least one processor is further configured for:
requiring substitution of at least one of the three real world players for at least one other real world player from the same team between each game of the real world team.

6. The system for fantasy games of claim 5 wherein the non-transitory computer program code comprising instructions executable by the at least one processor is further configured for:
designating one player on the real world team as a permanent member of the fantasy team, that is not required to be substituted.

7. The system for fantasy games of claim 1 wherein the non-transitory computer program code comprising instructions executable by the at least one processor is further configured for:
defining the fantasy team, as three real world players selected from a single real world team for each of a plurality of sports.

8. The system for fantasy games of claim 7 wherein the plurality of sports comprise at least two of:
professional football;
collegiate football;
professional baseball;
collegiate baseball;
professional basketball;
collegiate basketball;
professional soccer;
collegiate soccer;
professional hockey; and
collegiate hockey.

9. The system for fantasy games of claim 1 wherein the non-transitory computer program code comprising instructions executable by the at least one processor is further configured for:
awarding experience points according to the fantasy team performance.

10. The system for fantasy games of claim 1 wherein the non-transitory computer program code comprising instructions executable by the at least one processor is further configured for:
awarding digital awards according to the fantasy team performance.

11. A system for fantasy games comprising:
a computer system further comprising:
at least one processor;
a graphical user interface; and
a computer-usable medium embodying non-transitory computer program code, the computer-usable medium capable of communicating with the at least one processor, the non-transitory computer program code comprising instructions executable by the at least one processor and configured for:
defining a plurality of fantasy teams, each of the plurality of fantasy teams comprising three real world players selected from a single real world team;
collecting sports data comprising statistical data associated with the real world players;
assigning fantasy points to each of the plurality fantasy teams based on the sports data;
maintaining a leaderboard of the plurality of fantasy teams based on the fantasy points assigned to each of the plurality of fantasy teams.

12. The system for fantasy games of claim 11 wherein the non-transitory computer program code comprising instructions executable by the at least one processor is further configured for:
requiring substitution of at least one of the three real world players for at least one other real world player from the same team between each game of the real world team.

13. The system for fantasy games of claim 11 wherein the non-transitory computer program code comprising instructions executable by the at least one processor is further configured for:
defining the fantasy team, as three real world players selected from a single real world team for each of a plurality of sports.

14. A computer implemented fantasy game method comprising:
defining a first fantasy team, the first fantasy team comprising multiple real world players selected from a single real world team;
defining a second fantasy team, the second fantasy team comprising multiple real world players selected from a single real world team;
collecting sports data;
assigning fantasy points to the first fantasy team based on the sports data of the real world players selected from the single real world team to establish a first fantasy team score;
assigning fantasy points to the second fantasy team based on the sports data of the real world players selected from the single real world team to establish a second fantasy team score; and
identifying a winner between the first fantasy team and the second fantasy team by comparing the first fantasy team score and the second fantasy team score.

15. The computer implemented fantasy game method of claim 14 wherein the multiple real world players comprise three real world players.

16. The computer implemented fantasy game method of claim 15 further comprising:
requiring substitution of at least one of the three real world players for at least one other real world player from the same team between each game of the real world team.

17. The computer implemented fantasy game method of claim 14 further comprising:
defining the fantasy team, as three real world players selected from a single real world team for each of a plurality of sports.

18. The computer implemented method of claim 17 wherein the plurality of sports comprise at least two of:
professional football;
collegiate football;
professional baseball;
collegiate baseball;
professional basketball;
collegiate basketball;
professional soccer;
collegiate soccer;
professional hockey; and
collegiate hockey.

19. The computer implemented fantasy game method of claim 14 further comprising:
awarding experience points according to the fantasy team performance.

20. The computer implemented fantasy game method of claim 14 further comprising:
awarding digital awards according to the fantasy team performance.
